(19) United States
(12) Patent Application Publication
(10) Pub. No.: US 2010/0253227 A1
(43) Pub. Date: Oct. 7, 2010

(54) LIGHT FIXTURE AND DRIVING CIRCUIT THEREOF

(75) Inventors: Yi-Chao Chiang, Hsinchu County (TW); Ming-Ho Hsu, Tainan City (TW)

Correspondence Address: RABIN & Berdo, PC, 1101 14TH STREET, NW, SUITE 500, WASHINGTON, DC, 20005, US

(73) Assignee: Verticil Electronics Corp., Hsinchu City (TW)

(21) Appl. No.: 12/714,616

(22) Filed: Mar. 1, 2010

(30) Foreign Application Priority Data
Apr. 1, 2009 (TW) 098110910

(51) Int. Cl. H05B 41/36

(52) U.S. Cl. 315/127; 315/276; 315/277

(57) ABSTRACT

A light fixture includes a CCFL and a driving circuit. The driving circuit includes a first voltage converter and a high-voltage inverter. The first voltage converter provides a DC voltage signal according to a power signal. The high-voltage inverter comprises a second voltage converter and a first transformer. The second voltage converter converts the DC voltage signal into an AC voltage signal. The first transformer is corresponding to the first CCFL and includes a first primary winding circuit and a first secondary winding circuit. The first primary winding circuit has a first input voltage signal in response to the AC voltage signal. The first secondary winding circuit is coupled with the first input voltage signal to generate a first output voltage signal for driving the first CCFL. The first primary and secondary winding circuits belong to a primary-side circuit and receive the same ground voltage signal.

This application claims the benefit of Taiwan application Serial No. 98110910, filed Apr. 1, 2009, the subject matter of which is incorporated herein by reference.

### BACKGROUND OF THE INVENTION

1. Field of the Invention

The invention relates in general to a light fixture, and more particularly to a light fixture applying a cold cathode fluorescent lamp (CCFL) as a light source.

2. Description of the Related Art

In the technology of a light fixture for illumination, the light fixture using a fluorescent lamp as a light source has been very popular and widely applied in daily-life lighting. Generally speaking, the present light fixture uses a hot cathode fluorescence lamp (HCFL) as a light source. However, the HCFL has drawbacks of having short lifetime, large scale and low light emitting efficiency, being non-recyclable and generating a large amount of ultraviolet light. Therefore, how to design a fluorescent-lamp light fixture capable of effectively reducing the above drawbacks is one of the industrial's endeavors.

### SUMMARY OF THE INVENTION

The invention is directed to a light fixture using a CCFL for illumination. The lamp driving circuit applied in the light fixture of the invention does not require processing of high or low voltage insulation. In other words, the light fixture of the invention uses a driving circuit having only a primary-side circuit structure for driving the CCFL. Therefore, compared to the conventional light fixture, the light fixture of the invention has the advantages of having longer lamp lifetime, smaller scale and higher light emitting efficiency, being recyclable, and generating a smaller amount of ultraviolet light.

According to a first aspect of the present invention, a driving circuit for driving a first CCFL is provided. The driving circuit comprises a first voltage converter and a high-voltage inverter. The first voltage converter is for providing a direct-current (DC) voltage signal according to a power signal. The high-voltage inverter comprises a second voltage converter and a first transformer. The second voltage converter is for converting the DC voltage signal into an alternating-current (AC) voltage signal. The first transformer is corresponding to the first CCFL and comprises a first primary winding circuit and a first secondary winding circuit. The first primary winding circuit has a first input voltage signal in response to the AC voltage signal. The first secondary winding circuit is coupled with the first input voltage signal to generate a first output voltage signal for driving the first CCFL. The first primary winding circuit and the first secondary winding circuit belong to a primary-side circuit and receive the same ground voltage signal.

According to a second aspect of the present invention, a light fixture is provided. The light fixture comprises a first CCFL and a driving circuit. The driving circuit comprises a first voltage converter and a high-voltage inverter. The first voltage converter is for providing a DC voltage signal according to a power signal. The high-voltage inverter comprises a second voltage converter and a first transformer. The second voltage converter is for converting the DC voltage signal into an AC voltage signal. The first transformer is corresponding to the first CCFL and comprises a first primary winding circuit and a first secondary winding circuit. The first primary winding circuit has a first input voltage signal in response to the AC voltage signal. The first secondary winding circuit is coupled with the first input voltage signal to generate a first output voltage signal for driving the first CCFL. The first primary winding circuit and the first secondary winding circuit belong to a primary-side circuit and receive the same ground voltage signal.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a light fixture according to a preferred embodiment of the invention is shown.

FIG. 2 is a schematic diagram of the transformer in the light fixture of FIG. 1.

FIG. 3 is another block diagram of the light fixture according to the preferred embodiment of the invention.

FIG. 4 is a further block diagram of the light fixture according to the preferred embodiment of the invention.

FIG. 5 is a further block diagram of the light fixture according to the preferred embodiment of the invention.

FIG. 6 is a schematic diagram of the primary winding circuits and secondary winding circuits of FIG. 5.

FIG. 7 is a further block diagram of the light fixture according to the preferred embodiment of the invention.

FIG. 8 is a schematic diagram of the primary winding circuits and secondary winding circuits of FIG. 7.

FIG. 9 is a further block diagram of the light fixture according to the preferred embodiment of the invention.

FIG. 10 is a schematic diagram of the primary winding circuits and secondary winding circuits of FIG. 9.

FIG. 11 is a spectrum diagram of the CCFL according to the preferred embodiment of the invention.

### DETAILED DESCRIPTION OF THE INVENTION

The light fixture of the embodiment uses a driving circuit which has only a primary-side circuit structure for driving a CCFL.

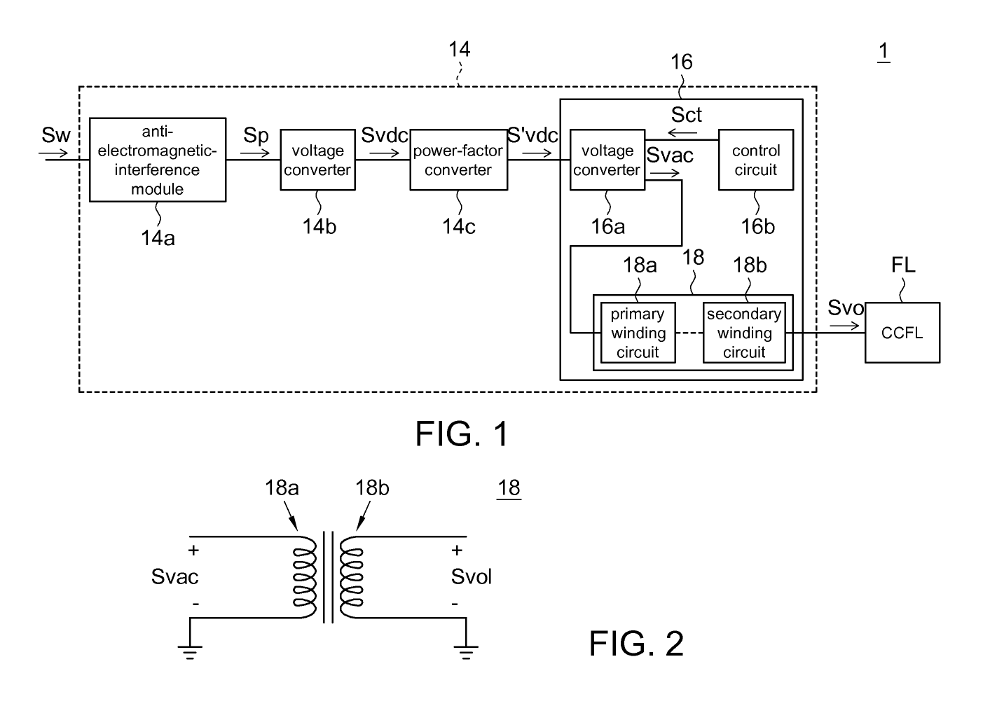

Referring to FIG. 1, a block diagram of a light fixture according to a preferred embodiment of the invention is shown. The light fixture 1 includes a CCFL FL and a driving circuit 14. For example, the driving circuit 14 is for receiving a local power signal Sw. The driving circuit 14 includes an anti-electromagnetic-interference module 14a, a voltage converter 14b and a high-voltage inverter 16. The anti-electromagnetic-interference module 14a is for performing an anti-electromagnetic-interference calibration on the local power signal Sw and accordingly generating the calibrated power signal Sp. The voltage converter 14b provides a DC voltage signal Svdc according to a power signal Sp. For example, the driving circuit 14 further includes a power-factor converter 14c for performing a power-factor calibration on the DC voltage signal Svdc provided by the voltage converter 14b and providing the calibrated DC voltage signal S′vdc to the high-voltage inverter 16.

The high-voltage inverter 16 includes a voltage converter 16a, a control circuit 16b and a transformer 18. The voltage converter 16a is controlled by a control signal Sct provided by the control circuit 16b to convert the DC voltage signal S′vdc into an AC voltage signal Svac. For example, the voltage converter 16a is a half bridge.

The transformer 18 is corresponding to the CCFL FL and includes a primary winding circuit 18a and a secondary winding circuit 18b. The primary winding circuit 18a has an input voltage signal (that is the AC voltage signal Svac) in response to the AC voltage signal Svac. The secondary winding circuit 18b is coupled with the input voltage signal of the primary winding circuit 18a to generate an output voltage signal Svo for driving the CCFL FL.

For example, the circuit structure of the transformer 18 is shown in FIG. 2. The operational voltage of the primary winding circuit 18a has a level close to that of the secondary winding circuit 18b. Only basic circuit insulation exists between the primary winding circuit 18a and the secondary winding circuit 18b. In other words, the primary winding circuit 18a and the secondary winding circuit 18b belong to a primary-side circuit with high or low voltage insulation and receive the same ground voltage signal.

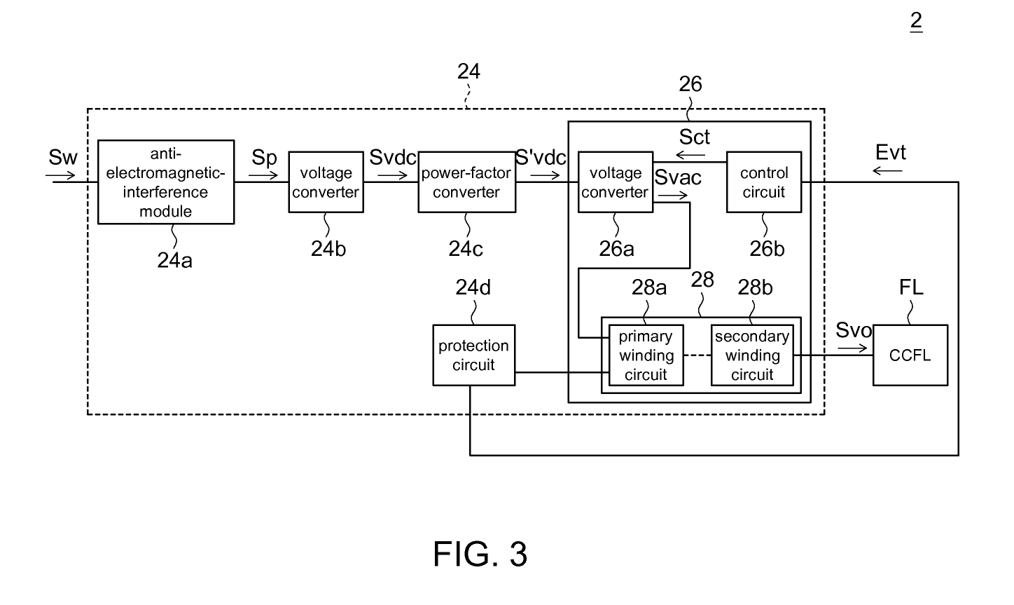

In one example, the driving circuit 24 includes a protection 24d for protecting the CCFL FL as shown in FIG. 3. The protection circuit 24d is for determining whether the input voltage signal of the primary winding circuit 18a satisfies a determination condition. For example, the determination condition is an event that the input voltage signal of the primary winding circuit 18a has a level larger than a predetermined voltage level. When the input voltage signal of the primary winding circuit 18a satisfies the determination condition, the protection circuit 24d determines that the CCFL FL is operating abnormally and triggers an operation-terminating event Evt.

The high-voltage inverter 26 of the driving circuit 24 is disabled in response to the operation-terminating event Evt to disable the output voltage signal Svo provided by the transformer 28 and the CCFL FL. For example, the control circuit 26b of the high-voltage inverter 26 disables the control signal Sct in response to the operation-terminating event Evt. Therefore, through disabling the voltage converter 26a, the AC voltage signal Svac, the input voltage signal of the primary winding circuit 28a, the output voltage signal Svo and the CCFL FL can be disabled.

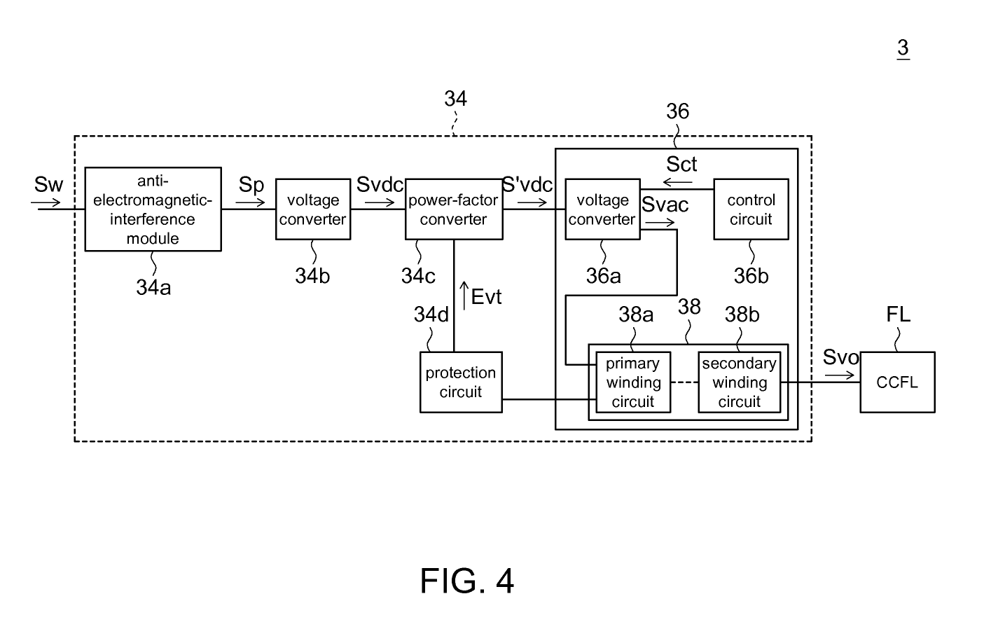

In another example, the protection circuit 34d of the driving circuit 34 provides the operation-terminating event Evt to the power-factor converter 34c and the power-factor converter 34c is disabled in response to the operation-terminating event Evt as shown in FIG. 4. Therefore, through disabling the power-factor converter 34c, the DC voltage signal S′vdc, the AC voltage signal Svac, the input voltage signal of the primary winding circuit 38a, the output voltage signal Svo and the CCFL FL can be disabled.

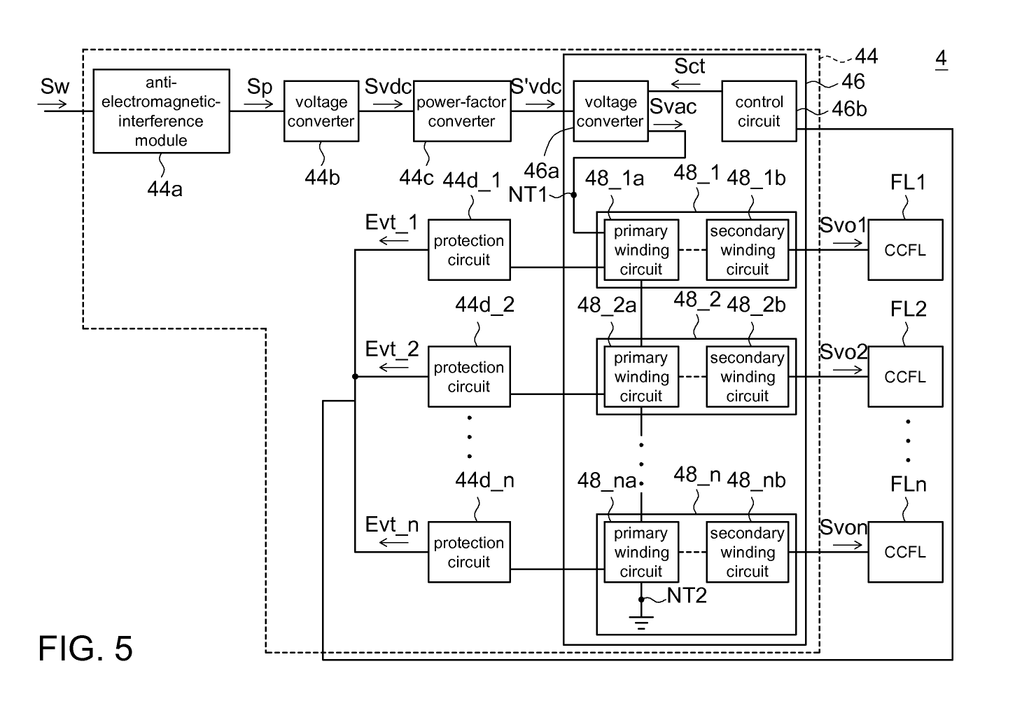

Although the high-voltage inverter 16 is exemplified to include a transformer 18 for driving one CCFL FL for illustration in the embodiment, the high-voltage converter 16 of the embodiment is not limited thereto. In another example, the high-voltage inverter 46′ includes a number of transformers 48_1, 48_2, . . . , 48_{—}n for respectively driving CCFLs FL1, FL2, . . . , FLn as shown in FIG. 5, wherein n is a natural number larger than 1.

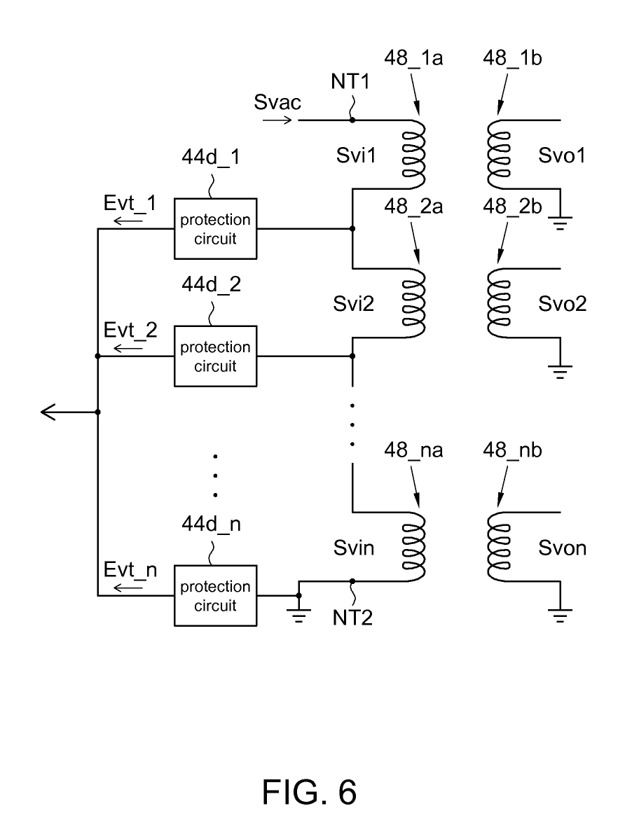

In one example, the primary winding circuits 48_1a˜48_{—}na of the transformers 48_1˜48_{—}n are coupled in series between the nodes NT1 and NT2 as shown in FIG. 6. The node NT1 receives the AC voltage signal Svac and the node NT2 receives the ground voltage signal. The primary winding circuits 48_1a˜48_{—}na, coupled in series between the nodes NT1 and NT2, are respectively biased to obtain the corresponding input voltage signals Svi1,Svi2, . . . , Svin in response to a voltage difference between the AC voltage signal Svac and the ground voltage signal. In one example, the input voltage signals Svi1˜Svin are respectively voltage drops across two terminals of the primary winding circuits 48_1a˜48_{—}na. The secondary winding circuits 48 _1b˜48_{—}nb are respectively coupled with the input voltage signals Svi1˜Svin to obtain output voltage signals Svo1, Svo2, . . . , Svon for driving the CCFLs FL1˜FLn. In one example, the output voltage signals Svo1˜Svon are respectively voltage drops across two terminals of the secondary winding circuits 48_1b˜48_{—}nb and the output voltage signals Svo1˜Svon as measured from the corresponding CCFLs FL1˜FLn have the same polarity.

In one example, the driving circuit 44 includes n protection circuits 44d_1, 44d_2, . . . , 44d_{—}n for respectively determining whether the input voltage signals Svi1˜Svin satisfy a determination condition. In one example, the input voltage signals Svi1˜Svin as measured from the protection circuits 44d_1˜44d_{—}n have the same polarity, and the determination condition is that the input voltage signal Svi1˜Svin has a level larger than a predetermined voltage level. When any one of the input voltage signals Svi1, . . . , or Svin satisfies the determination condition, the corresponding protection circuit 44d_1, . . . , or 44d_{—}n determines that the CCFL FL1, . . . , or FLn is operating abnormally and triggers the corresponding operation-terminating event. The operation-terminating event is provided to the control circuit 46b to protect the corresponding CCFL FL1, . . . , or FLn through control of the high-voltage inverter 46.

Although the input voltage signals Svo1˜Svon are exemplified to be respectively the voltage drops across two terminals of the primary winding circuits 48_1a˜48_{—}na in the embodiment, the transformers of the embodiment are not limited thereto. In another example, each input voltage signal Svo1˜Svon can also be a voltage drop across one terminal of the corresponding primary winding circuit 48_1a˜48_{—}na and the AC voltage signal Svac or a voltage drop across one terminal of the corresponding primary winding circuit 48_1a˜48_{—}na and the ground voltage signal.

Although the input voltage signals Svi1˜Svin as measured from the protection circuits 44d_1˜44d_{—}n are exemplified to have the same polarity for illustration in the embodiment, the transformer of the embodiment is not limited thereto. In another example, a portion of the input voltage signals Svi1˜Svin can also have a positive polarity and the other portion of them have a negative polarity as measured from the corresponding protection circuits 44d_1˜44d_{—}n. Each of the protection circuits 44d_1˜44d_{—}n determines whether the corresponding CCFL FL1˜FLn has a normal operation according to an absolution of the observed input voltage signal Svi1˜Svin and an absolution of the predetermined voltage.

Although the output voltage signals Svo1˜Svon as measured from the CCFLs FL1˜FLn are exemplified to have the same polarity for illustration in the embodiment, the transformers of the embodiment are not limited thereto. In another example, a portion of the output voltage signals Svo1˜Svon can also have a positive polarity and the other portion of them have a negative polarity as measured from the corresponding CCFL FL1˜FLn. For example, the output signals as measured from the odd-numbered CCFLs have the positive polarity while the output signals as measured from the even-numbered CCFLs have the negative polarity.

In another example, the operation-terminating events can also be provided to the power-factor converter 44c to protect the CCFLs FL1˜FLn through control of the power-factor converter 44c.

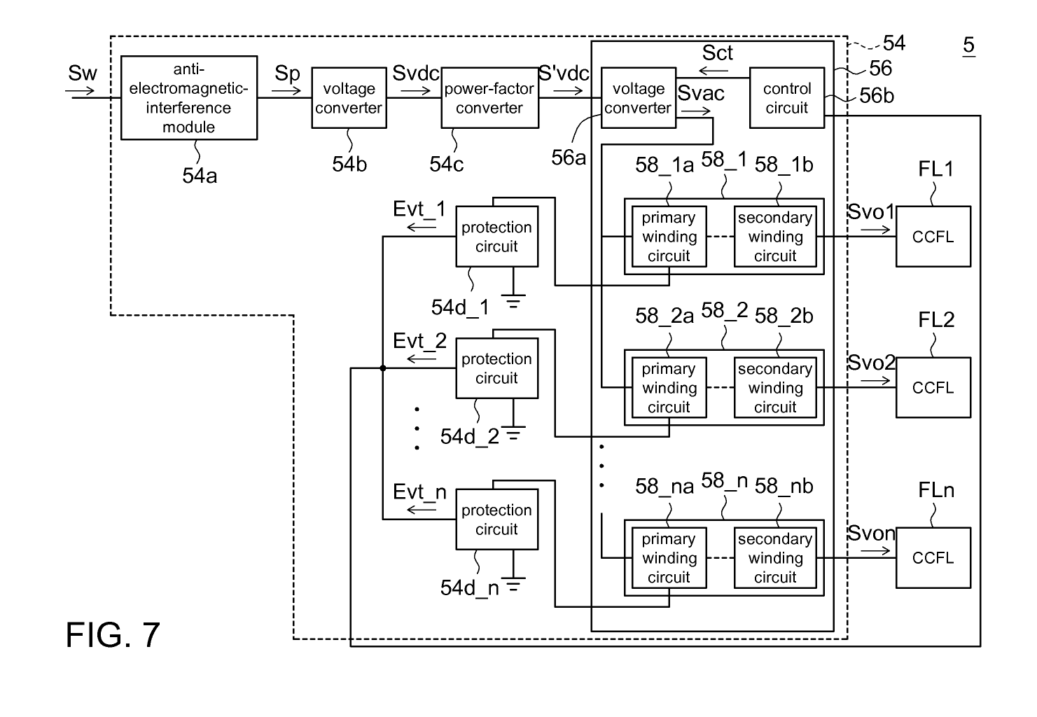

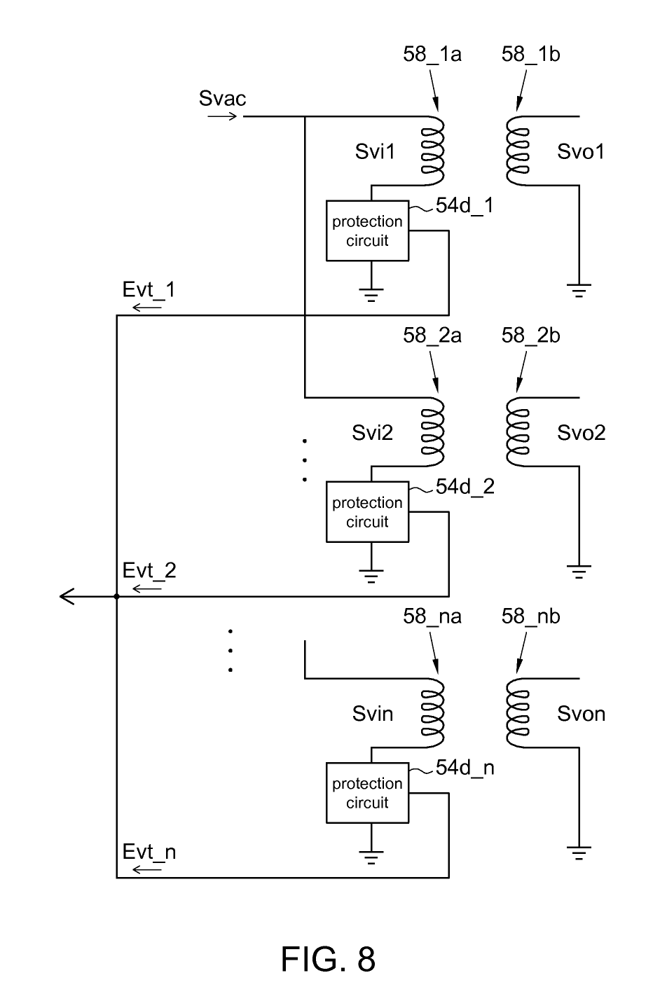

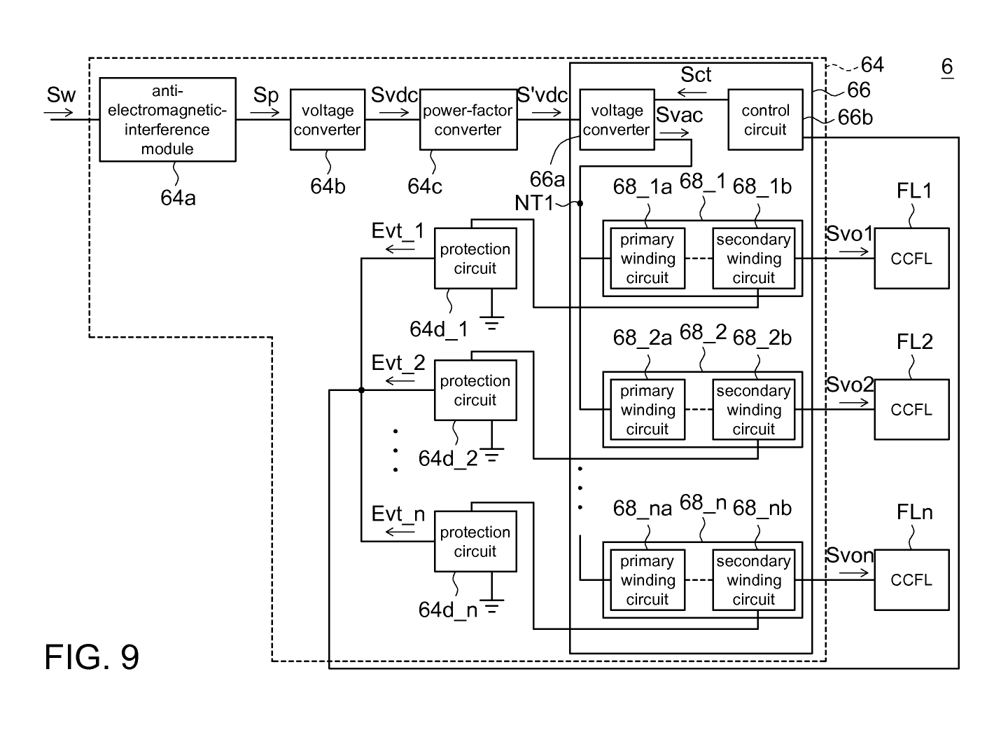

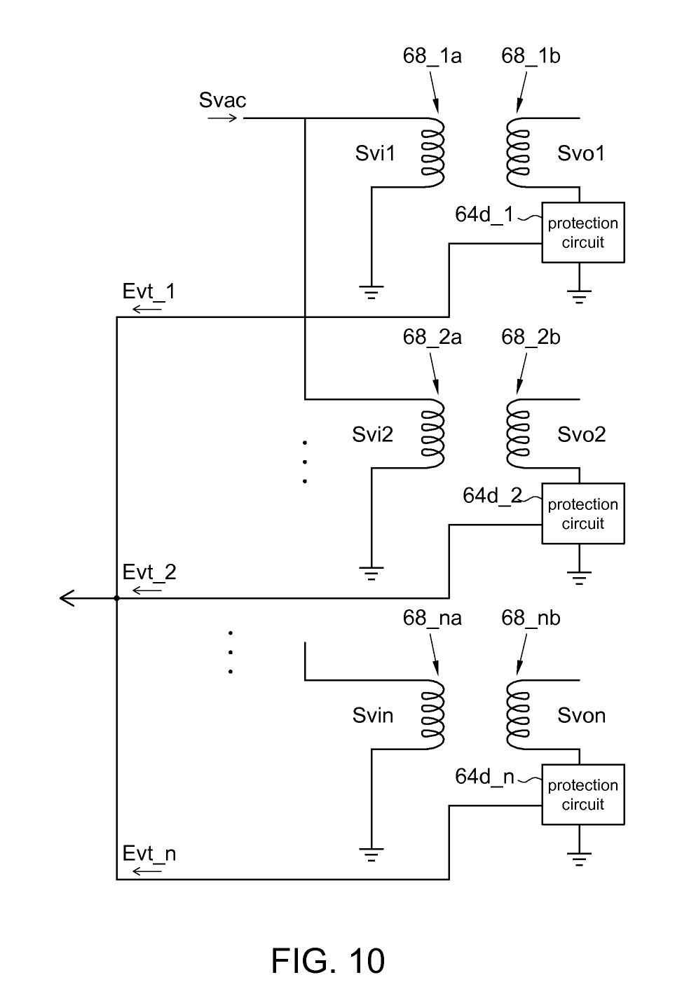

Although the primary winding circuits 48_1a˜48_{—}na of the transformers 48_1˜48_{—}n are coupled in series between the nodes NT1 and NT2 for illustration in the embodiment, the transformers of the embodiment are not limited thereto. In one example, the primary winding circuits 58_1a˜58_{—}na of the transformers 58_1˜58_{—}n are coupled to each other in parallel as shown in FIGS. 7 and 8. The protection circuits 54d_1˜54d_{—}n respectively provide the corresponding operation-terminating events according to voltages of the primary winding circuits 58_1a˜58_{—}na. In another example, the primary winding circuits 68_1b˜68_{—}nb of the transformers 68_1˜68_{—}n are coupled to each other in parallel as shown in FIGS. 9 and 10, and the protection circuits 64d_1˜64d_{—}n respectively provide the corresponding operation-terminating events according to voltages of the secondary winding circuits 68_1b˜68_{—}nb.

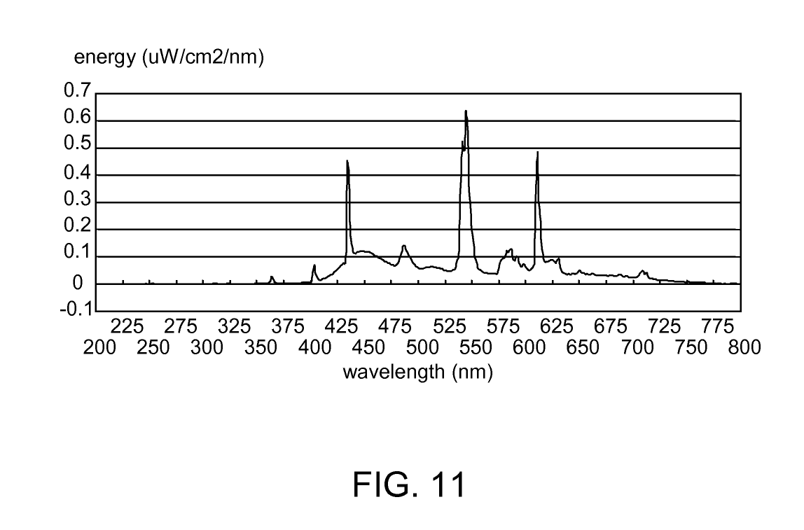

The light fixture of the embodiment uses the CCFL for illumination. Normally speaking, the CCFL has the specification that the lifetime is about 50000 hours, the lamp has a diameter about 2 mm, and energy distribution of the (ultraviolet) light having a wavelength smaller than 330 nm in light spectrum is zero as shown in FIG. 11. Therefore, compared to the conventional light fixture using HCFL which has a lifetime of about 6000˜10000 hours, a diameter of 0.25˜1 inch and approximately a spectrum of the natural light, the light fixture of the embodiment has advantages of having longer lifetime, smaller lamp size, smaller light-fixture scale, better light emitting efficiency and ultraviolet-light resistance, and using a smaller amount of phosphor.

Besides, the light fixture of the embodiment uses a driving circuit which has only a primary-side circuit structure for driving the CCFL and thus has the advantage of lower cost.

Further, the light fixture of the embodiment uses the protection circuit disposed at the primary side to protect the CCFL disposed at the secondary side. Compared to the secondary side, the primary side requires a lower operational voltage and a smaller circuit-safety interval. Therefore, disposition of the protection circuit at the primary side can further reduce a circuit size of the driving circuit for driving the CCFL.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A driving circuit for driving a first cold cathode fluorescent lamp (CCFL), comprising:
a first voltage converter for providing a direct-current (DC) voltage signal according to a power signal;
a high-voltage inverter, comprising:
a second voltage converter for converting the DC voltage signal into an alternating-current (AC) voltage signal; and
a first transformer corresponding to the first CCFL, the first transformer comprising:
a first primary winding circuit, having a first input voltage signal in response to the AC voltage signal; and
a first secondary winding circuit, coupled with the first input voltage signal to generate a first output voltage signal for driving the first CCFL;
wherein the first primary winding circuit and the first secondary winding circuit belong to a primary-side circuit and receive the same ground voltage signal.

2. The driving circuit according to claim 1, further comprising:
a protection circuit, for determining whether the first input voltage signal satisfies a determination condition, wherein when the first input voltage satisfies the determination condition, the protection circuit determines that the first CCFL is operating abnormally and triggers an operation-terminating event.

3. The driving circuit according to claim 2, wherein the high-voltage inverter is disabled in response to the operation-terminating event to disable the first output voltage signal provided by the first transformer.

4. The driving circuit according to claim 2, further comprising:
a power-factor converter, for performing a power-factor calibration on the DC voltage signal provided by the first voltage converter and providing the calibrated DC voltage signal to the high-voltage inverter;
wherein the power-factor converter is disabled in response to the operation-terminating event to disable the DC voltage signal, the first input voltage signal and the first output voltage signal.

5. The driving circuit according to claim 1, further comprising:
a protection circuit, for determining whether the first output voltage signal satisfies a determination condition, wherein when the first output voltage satisfies the determination condition, the protection circuit determines that the first CCFL is operating abnormally and triggers an operation-terminating event.

6. The driving circuit according to claim 1, further comprising:
an anti-electromagnetic-interference module, for performing an performing an anti-electromagnetic-interference calibration on the power signal and providing the calibrated power signal to the first voltage converter.

7. The driving circuit according to claim 1, further driving a second CCFL, wherein the high-voltage inverter further comprises a second transformer, the second transformer comprises:
a second primary winding circuit, belonging to the primary-side circuit, wherein the second primary-side circuit has a second input voltage signal in response to the AC voltage signal; and
a second secondary winding circuit, belonging to the primary-side circuit, wherein the second secondary winding circuit is coupled with the second input voltage signal to generate a second output voltage signal for driving the second CCFL.

8. The driving circuit according to claim 7, wherein the high-voltage inverter further comprises:
a first node and a second node, for respectively receiving the AC voltage signal and a ground voltage signal, wherein the first and the second primary winding circuits are coupled in series between the first node and the second node, and the first and the second primary winding circuits are respectively biased to obtain the first and the second input voltage signals in response to the AC voltage signal and the ground voltage signal.

9. The driving circuit according to claim 7, wherein the first and the second primary winding circuits are coupled to each other in parallel.

10. A light fixture, comprising:
a first CCFL;
a driving circuit, comprising:
a first voltage converter, for providing a DC voltage signal according to a power signal; and
a high-voltage inverter, comprising:
a second voltage converter, for converting the DC voltage signal to generate an AC voltage signal; and
a first transformer, corresponding to the first CCFL, the first transformer comprising:
a first primary winding circuit, having a first input voltage signal in response to the AC voltage signal; and
a first secondary winding circuit, coupled with the first input voltage signal to generate a first output voltage signal for driving the first CCFL;
wherein the first primary winding circuit and the first secondary winding circuit belong to a primary-side circuit and receive the same ground voltage signal.

11. The light fixture according to claim 10, further comprising:
a protection circuit, for determining whether the first input voltage signal satisfies a determination condition, wherein when the first input voltage signal satisfies the determination condition, the protection circuit determines that the first CCFL is operating abnormally and triggers an operation-terminating event.

12. The light fixture according to claim 11, wherein the high-voltage inverter is disabled in response to the operation-terminating event to disable the first output voltage signal provided by the first transformer.

13. The light fixture according to claim 11, further comprising:
a power-factor converter, for performing a power-factor calibration on the DC voltage signal provided by the first voltage converter and providing the calibrated DC voltage signal to the high-voltage inverter;
wherein the power-factor converter is disabled in response to the operation-terminating event to disable the DC voltage signal, the first input voltage signal and the first output voltage signal.

14. The light fixture according to claim 10, further comprising:
a protection circuit, for determining whether the first output voltage signal satisfies a determination condition, wherein when the first output voltage signal satisfies the determination condition, the protection circuit determines that the first CCFL is operating abnormally and triggers an operation-terminating event.

15. The light fixture according to claim 10, further comprising a second CCFL, wherein the high-voltage inverter further comprises a second transformer, the second transformer comprises:
a second primary winding circuit, belonging to the primary-side circuit, wherein the second primary-side circuit has a second input voltage signal in response to the AC voltage signal; and
a second secondary winding circuit, belonging to the primary-side circuit, wherein the second secondary winding circuit is coupled with the second input voltage signal to generate a second output voltage signal for driving the second CCFL.

16. The light fixture according to claim 15, wherein the high-voltage inverter further comprises:
a first node and a second node, for respectively receiving the AC voltage signal and a ground voltage signal, wherein the first and the second primary winding circuits are coupled in series between the first node and the second node, and the first and the second primary winding circuits are respectively biased to obtain the first and the second input voltage signals in response to the AC voltage signal and the ground voltage signal.

17. The light fixture according to claim 16, wherein the first and the second primary winding circuits are coupled to each other in parallel.

18. The light fixture according to claim 10, further comprising:
an anti-electromagnetic-interference module, for performing an performing an anti-electromagnetic-interference calibration on the power signal and providing the calibrated power signal to the first voltage converter.
